(19) United States
(12) Patent Application Publication
(10) Pub. No.: US 2017/0182903 A1
(43) Pub. Date: Jun. 29, 2017

(54) Technologies for wireless charging of electric vehicles

(71) Applicant: Intel Corporation, Santa Clara, CA (US)

(72) Inventors: Robert F. Kwasnick, Palo Alto, CA (US); Suraj Sindia, Hillsboro, OR (US); Zhen Yao, San Jose, CA (US)

(21) Appl. No.: 14/998,305

(22) Filed: Dec. 26, 2015

(51) Int. Cl. B60L 11/18

(52) U.S. Cl. CPC B60L 11/1829; B60L 11/182; B60L 11/1835

(57) ABSTRACT

Technologies for wireless charging of an electric vehicle include moving a first coil toward a second coil based on a sensed distance between the first coil and the second coil. In an embodiment, the first coil is embodied as a power transmission coil that is moved toward the second coil, which is embodied as a power receiving coil located in the electric vehicle. The power transmission coil may be moved vertically from a roadway or other substrate beneath the electric vehicle. In another embodiment, the first coil may be embodied as the power receiving coil located in the electric vehicle that is moved downwardly from the electric vehicle toward the second coil, which is embodied as the power transmission coil. In such embodiments, the power transmission coil may be embodied in the roadway or other substrate beneath the electric vehicle. Additional technologies for controlling the movement and transfer of power of the coils are also disclosed.

### BACKGROUND

Electric vehicles have several advantages compared to traditional internal-combustion vehicles. For example, electric vehicles run quieter, are more efficient to operate, have no tailpipe emissions, and may be less expensive to operate. One drawback for electric vehicles is the requirement that their local energy sources (e.g., batteries) must be periodically charged, often requiring that the electric vehicle be plugged in to a primary power source (e.g., the grid) regularly, typically overnight or when otherwise parked.

Wireless power transfer using resonant inductive coupling allows for contactless charging over a relatively long distance, up to several times the coil diameter under optimal conditions. However, resonant inductive power transfer can have low efficiency under less-than-optimal conditions, and can still significantly benefit from operating over shorter distances. For example, wireless power transfer technologies have been recently used to charge cell phones and other small devices using a charge plate on which the cell phone is set when not in use.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for wireless charging of an electric vehicle;

FIG. 2 is a simplified illustration of at least one embodiment of the system of FIG. 1 having a power transmission coil moved to a non-charging position;

FIG. 3 is a simplified illustration of the system of FIG. 2 having the power transmission coil moved to a charging position;

FIG. 4 is a simplified illustration of at least one additional embodiment of the system of FIG. 1 having a power receiving coil moved to a non-charging position;

FIG. 5 is a simplified illustration of the system of FIG. 4 having the power receiving coil moved to a charging position;

FIG. 6 is a simplified block diagram of at least one embodiment of a power transfer controller of the system of FIG. 1;

FIG. 7 is a simplified block diagram of at least one embodiment of a power transmission circuit of the system of FIG. 1;

FIG. 8 is a simplified block diagram of at least one embodiment of a power receiving circuit of the system of FIG. 1;

FIG. 9 is a block diagram of at least one embodiment of an environment that may be established by the power transfer controller of FIG. 6;

FIGS. 10 and 11 are a simplified flow diagram of at least one embodiment of a method for wireless charging an electric vehicle that may be executed by the power transfer controller of FIG. 6;

FIG. 12 is a simplified illustration of at least one embodiment of the system of FIG. 1 having a power transmission coil embodied as several sub-coils moved to a non-charging position; and

FIG. 13 is a simplified illustration of the system of FIG. 12 having some of the sub-coils moved to a charging position;

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

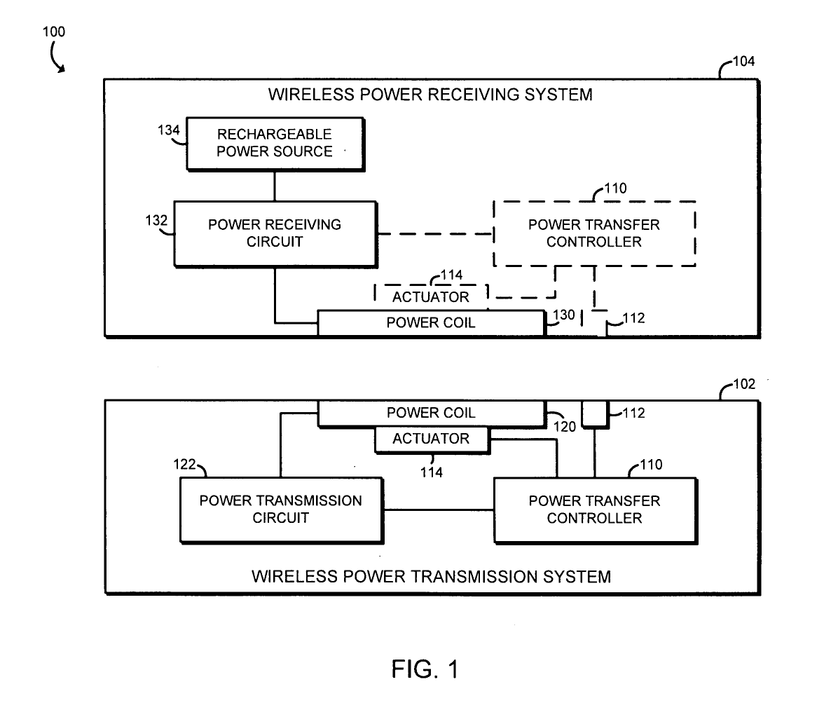

Referring now to FIG. 1, an illustrative system 100 for wirelessly charging an electric vehicle includes a wireless power transmission system 102 and a wireless power receiving system 104. The wireless power transmission system 102 includes a power transmission circuit 122 configured to energize a power coil 120 to transfer power to a corresponding power coil 130 of the wireless power receiving system 104. The wireless power receiving system 104 includes a power receiving circuit 132 to receive the power transferred to the power coil 130 and control charging of a rechargeable power source 134 (e.g., a battery). For example, in the illustrative embodiment, the wireless power receiving system 104 is located in an electric vehicle and configured to control recharging of a rechargeable battery of the electric vehicle.

In use, at least one of the power coils 120, 130 is configured to be moved toward the other power coil 120, 130 to facilitate the transfer of power from the power coil 120 to the power coil 130 via resonant inductive charging. Because both the amount of the power transfer and the efficiency of the power transfer depend on the distance between the power coils 120, 130, at least one of the power coils 120, 130 is moved toward the other power coil 120, 130 to reduce the distance between the power coils 120, 130. With a smaller distance between the power coils 120, 130, a higher power transfer for similar field strengths may be achieved, or, alternatively, a lower field for similar power transfer may be achieved, which may be desirable from a safety perspective if field strength is a concern.

In the illustrative embodiment of FIG. 1, the wireless power transmission system 102 includes a power transfer controller 110 configured to control an actuator 114 operatively coupled to the power coil 120 to move the power coil 120 toward the power coil 130. To do so, the wireless power transmission system 102 includes a proximity sensor 112 to produce or generate sensor data indicative of a distance between the power coils 120, 130. As such, the power transfer controller 110 controls the actuator to move the power coil 120 toward the power coil 130 based on the sensed distance between the power coils 120, 130 (e.g., to move the power coil to within a reference distance of the power coil 130).

In other embodiments, the power transfer controller 110 may be located in the wireless power receiving system 104 as shown in dashed lines in FIG. 1. In such embodiments, the power transfer controller 110 is configured to control the actuator 114, which is operatively coupled to the power coil 130, to move the power coil 130 toward the power coil 120. Again, to do so, the power transfer controller 110 controls the actuator 114 to move the power coil 130 toward the power coil 120 based on sensor data produced by the proximity sensor 112, which may be included in the wireless power receiving system 104. Of course, in yet other embodiments, each of the wireless power transmission system 102 and the wireless power receiving system 104 may include a local power transfer controller 110 to move each corresponding power coil 120, 130 toward each other.

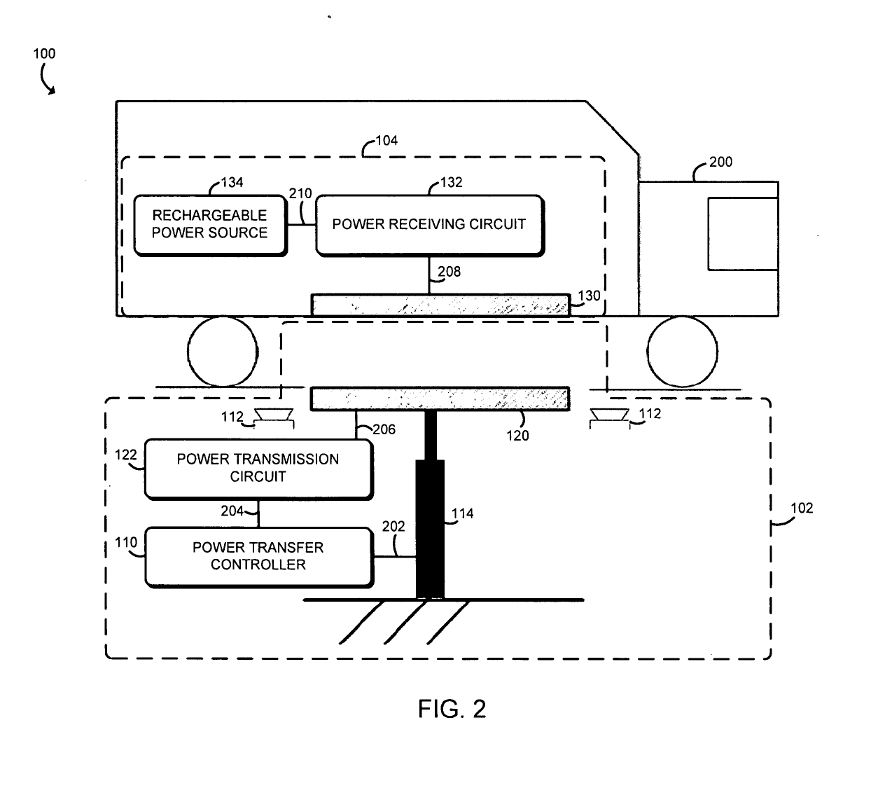

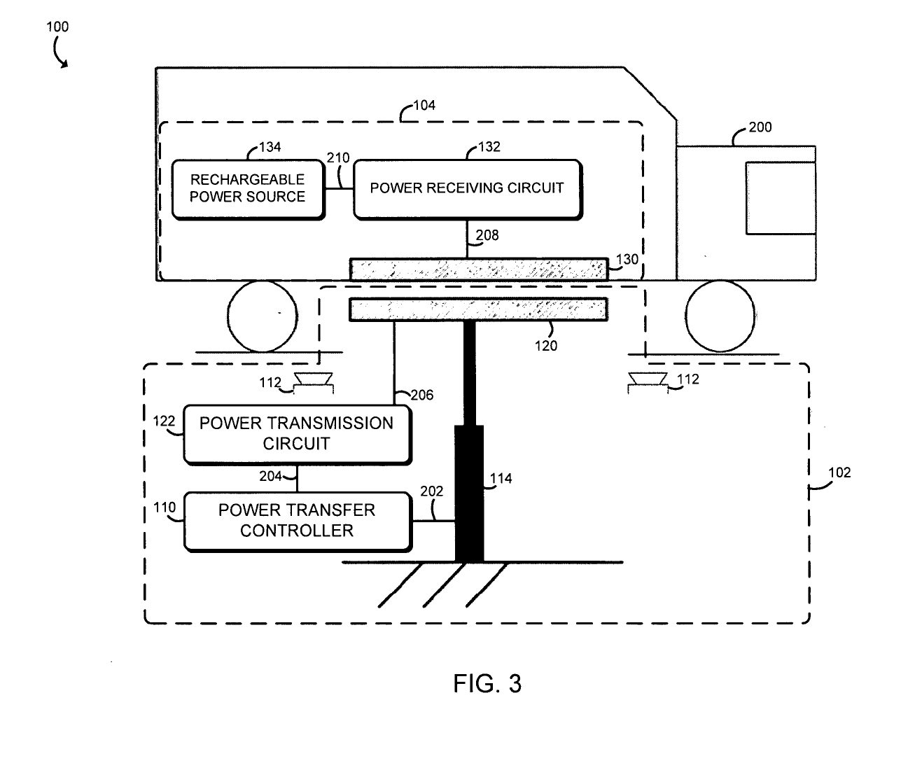

Referring now to FIGS. 2 and 3, an illustrative embodiment of the system 100 is shown in which the power transfer controller 110 is included in the wireless power transmission system 102 and the wireless power receiving system 104 is included in an electric vehicle 200. In use, the electric vehicle 200 is positioned over the wireless power transmission system 102 such that the power coil 130, which is embodied as a power receiving coil 130, is located over the power coil 120, which is embodied as a power transmission coil 120. For example, the electric vehicle 200 may be parked over the wireless power transmission system 102, which may be embodied in a user's garage, a parking lot, or other area capable of supporting the electric vehicle. In some embodiments, the power transfer controller 110 may sense the proper positioning of the electric vehicle 200 via, for example, sensor data from the proximity sensors 112.

After the electric vehicle 200 is properly position as shown in FIG. 2, the power transfer controller 110 controls the actuator 114 to move the power transmission coil 120 upwardly toward the power receiving coil 130 in a vertical direction as shown in FIG. 3. For example, in the illustrative embodiment, the power transfer controller 110 controls the actuator 114 via control signals sent over a control bus 202. The power transfer controller 110 moves the power transmission coil 120 toward power receiving coil 130 until the power transmission coil 120 is within a reference distance of the power receiving coil 130 based on the sensor data produced by the proximity sensors 112. As discussed in more detail below, the reference distance to be achieved between the power coils 120, 130 may be based on a desired minimum wireless power transfer efficiency.

After the power transmission coil 120 has been properly positioned, the power transfer controller 110 controls the power transmission circuit 122, via a control bus 204, to energize the power transmission coil 120. In response, power is transferred to the power receiving coil 130, and received by the power receiving circuit 132, which is coupled to the power receiving coil 130 over a power bus 208. The power receiving circuit 124 may utilize the power to recharge the rechargeable power source 134 and/or for other tasks related to powering of the electric vehicle 200.

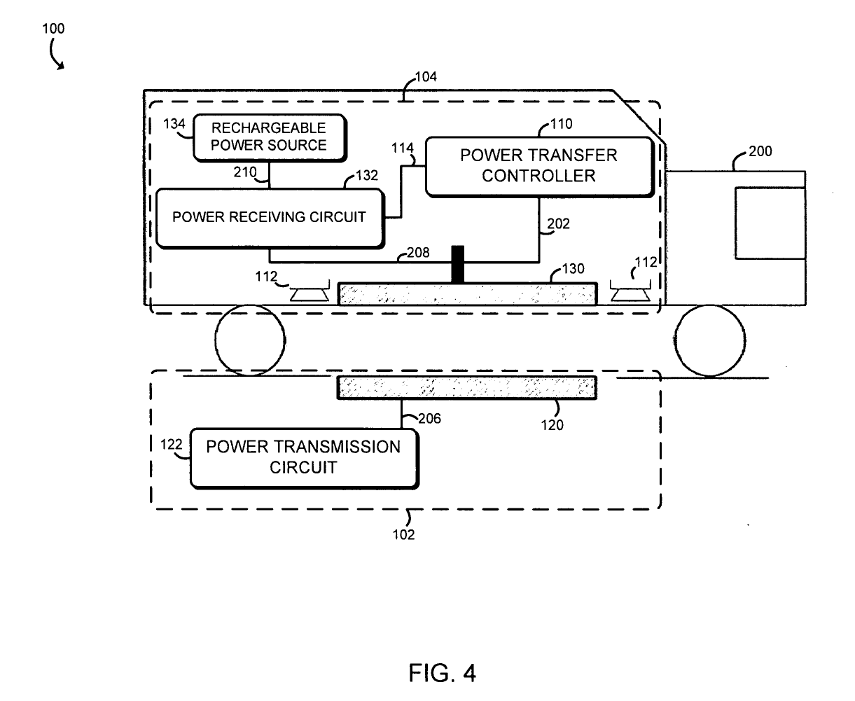

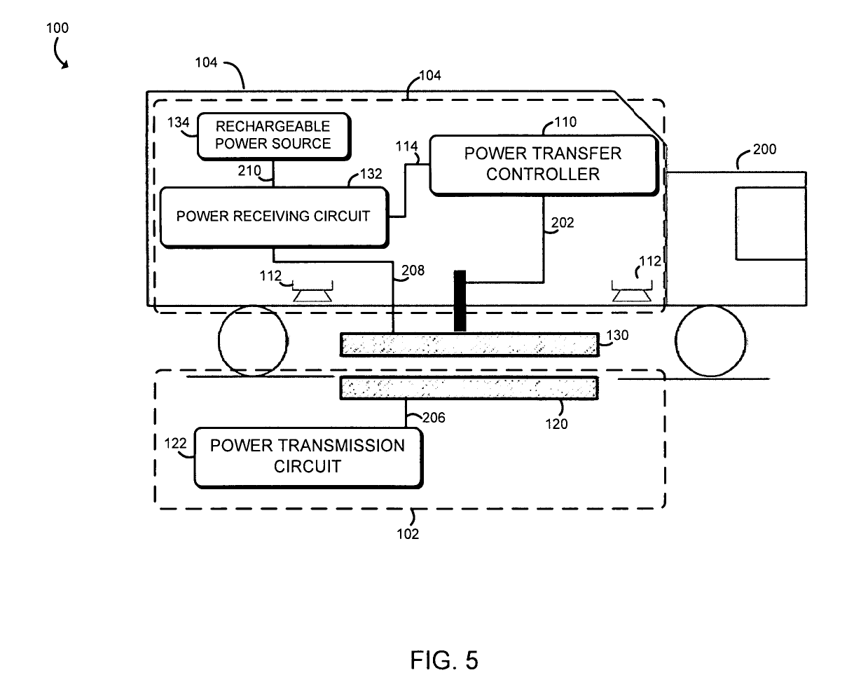

Referring now to FIGS. 4 and 5, another illustrative embodiment of the system 100 is shown in which the power transfer controller 110 is included in the wireless power receiving system 104, which is again included in the electric vehicle 200. In the illustrative embodiment, the power receiving coil 130 is movable toward the power transmission coil 120 to effect power transfer between the power coils 120, 130 as discussed below. To do so, the electric vehicle 200 is positioned over the wireless power transmission system 102 such that the power receiving coil 130 is located over the power transmission coil 120. Again, the power transfer controller 110 may sense the proper positioning of the power receiving coil 130 relative to the power transmission coil 120 via sensor data generated by the proximity sensors 112, which are illustratively included in the wireless power receiving system 104.

After the electric vehicle 200 is properly position as shown in FIG. 4, the power transfer controller 110 controls the actuator 114, which is also included in the wireless power receiving system 104, to move the power receiving coil 130 downwardly toward the power transmission coil 120 in a vertical direction as shown in FIG. 5. Again, to do so, the power transfer controller 110 may control the actuator 114 via control signals sent over the control bus 202. The power transfer controller 110 moves the power receiving coil 130 toward power transmission coil 120 until the power receiving coil 130 is within the reference distance of the power transmission coil 120 based on the sensor data produced by the proximity sensors 112. Again, the reference distance to be achieved between the power coils 120, 130 may be based on a desired minimum wireless power transfer efficiency.

After the power receiving coil 130 has been properly positioned, the power transmission circuit 122 energizes the power transmission coil 120 to transfer power to the power receiving coil 130. In some embodiments, the power transfer controller 110 may control the power transmission circuit 122, or another control circuit configured to control the operation of the power transmission circuit 122, to initiate the energizing of the power transmission coil 120. For example, the power transfer controller 110 may wirelessly transmit control signals to the power transmission circuit 122. In other embodiments, the wireless power transmission system 102 may include additional sensors to sense when the power receiving coil 130 is properly positioned (or when the electric vehicle is properly located) and initiate energizing of the power transmission coil 120 in response thereto. Regardless, the power from the power receiving coil 130 is received by the power receiving circuit 132, which may utilize the power to recharge the rechargeable power source 134 and/or for other tasks related to powering of the electric vehicle 200.

It should be appreciated that, in the embodiment of FIGS. 4 and 5, the electric vehicle 200 may be stationary or in motion during the power transfer. For example, in some embodiments as discussed above, the wireless power transmission system 102 may be embedded in a garage or parking lot and the electric vehicle 200 may be parked over the wireless power transmission system 102 to effect the power transfer. Alternatively, because the power receiving coil 130 is moved in the embodiment of FIGS. 4 and 5 rather than the power transmission coil 120, the electric vehicle 200 may be in motion during the power transfer. For example, the wireless power transmission system 102 may be embedded in a roadway or “charging lane” and include multiple power transmission coils 120 arranged in a sequential line. In such embodiments, the power transmission coils 120 may be energized while the electric vehicle 200, with the power receiving coil 130 lowered as in FIG. 5, is driven over the power transmission coils 120 to transfer power to the power receiving coil 130.

Of course, it should be appreciated that embodiments of the system 100 in addition to those depicted in FIGS. 2-5 are also possible. For example, in the embodiment of FIGS. 2 and 3, the proximity sensors 112 may be included in the wireless power receiving system 104 and the movement of the power transmission coil 120 may be controlled by a power transfer controller included in the wireless power receiving system 104 based on the sensor data received from the proximity sensors 112 as discussed above. In such embodiments, the power transfer controller of the wireless power receiving system 104 may transmit control signals to a power transfer controller of the wireless power transmission system 102 to control the movement of the power transmission coil 120.

As such, although components of the system 100 are described below in reference to the embodiment of FIGS. 2 and 3 for clarity of the description, it should be appreciated that such description may be applicable to other embodiments. Additionally, some described components may be located elsewhere in the system 100 in some embodiments (e.g., in the wireless power receiving system 104 instead of the wireless power transmission system 102), although the description may be equally applicable.

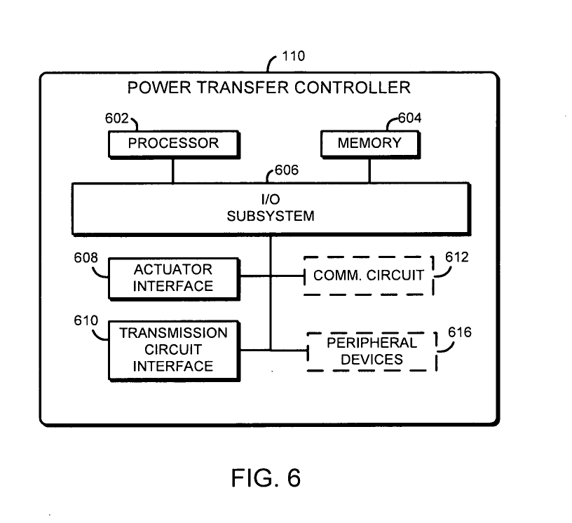

Referring now to FIG. 6, the power transfer controller 110 may be embodied as any type of computing device or controller capable of controlling the actuator 114 and performing the additional functions described herein. For example, the power transfer controller 110 may be embodied as a computer, an embedded computing system, a System-on-a-Chip (SoC), a programmable logic controller (PLC), a multiprocessor system, a processor-based system, a and/or any other computing or controller device. In the illustrative embodiment, the power transfer controller 110 includes a processor 602, a memory 604, an I/O subsystem 606, an actuator interface 608, and a transmission circuit interface 610. In some embodiments, one or more of the illustrative components of the power transfer controller 110 may be incorporated in, or otherwise form a portion of, another component. For example, the memory 604, or portions thereof, may be incorporated in the processor 602 in some embodiments.

The processor 602 may be embodied as any type of processor capable of performing the functions described herein. For example, the processor 602 may be embodied as a single or multi-core processor(s), a single or multi-socket processor, a digital signal processor, a microcontroller, or other processor or processing/controlling circuit. Similarly, the memory 604 may be embodied as any type of volatile or non-volatile memory or data storage capable of performing the functions described herein. In operation, the memory 604 may store various data and software used during operation of the power transfer controller 110 such as operating systems, applications, programs, libraries, and drivers. The memory 604 is communicatively coupled to the processor 602 via the I/O subsystem 606, which may be embodied as circuitry and/or components to facilitate input/output operations with the processor 602, the memory 604, and other components of the power transfer controller 110. For example, the I/O subsystem 606 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 606 may form a portion of a system-on-a-chip (SoC) and be incorporated, along with the processor 602, the memory 604, and other components of the power transfer controller 110 on a single integrated circuit chip.

The actuator interface 608 may be embodied as any type of circuitry and/or device, such as an input/output interface, capable of interfacing with the control bus 202 or otherwise communicating with the actuator 114 for controlling movement of the corresponding power coil 120, 130. To do so, the actuator interface 608 may utilize any suitable communication technology and/or protocol including, but not limited to Controller Area Network (CAN), a serial connection such as RS-232, a wireless connection such as Wi-Fi® or Bluetooth®, an Ethernet connection, a Universal Serial Bus (USB), etc.

The transmission circuit interface 610 may be embodied as any type of circuitry and/or device, such as an input/output interface, capable of interfacing with the control bus 204 or otherwise communicating with the power transmission circuit 122 to control the energizing of the power transmission coil 120. To do so, the transmission circuit interface may utilize any suitable communication technology and/or protocol including, but not limited to Controller Area Network (CAN), a serial connection such as RS-232, a wireless connection such as Wi-Fi® or Bluetooth®, an Ethernet connection, a Universal Serial Bus (USB), etc. For example, in embodiments in which the power transfer controller 110 is included in the wireless power receiving system 104, the transmission circuit interface 610 may be embodied as a wireless communication interface to communicate with the power transmission circuit 122.

Of course, in some embodiments, the power transfer controller 110 may include other or additional components, such as those commonly found in a computing device. For example, the power transfer controller 110 a communication circuit 612, which may be embodied as any type of communication circuit, device, or collection thereof, capable of enabling communications between the power transfer controller 110 and other devices of the system 100 (e.g., the electric vehicle 200, the power transmission circuit 122, etc.) To do so, the communication circuit 612 may be configured to use any one or more communication technology and associated protocols listed above (e.g., Ethernet, Bluetooth®, Wi-Fi®, WiMAX, NFC, etc.) to effect such communication.

The power transfer controller 110 may additionally include one or more peripheral devices 616 in some embodiments. Such peripheral devices 616 may include any type of device commonly found in computing devices including, but not limited to, data storage devices, input devices such as a keyboard or mouse, output devices such as a speaker or display, and/or other devices.

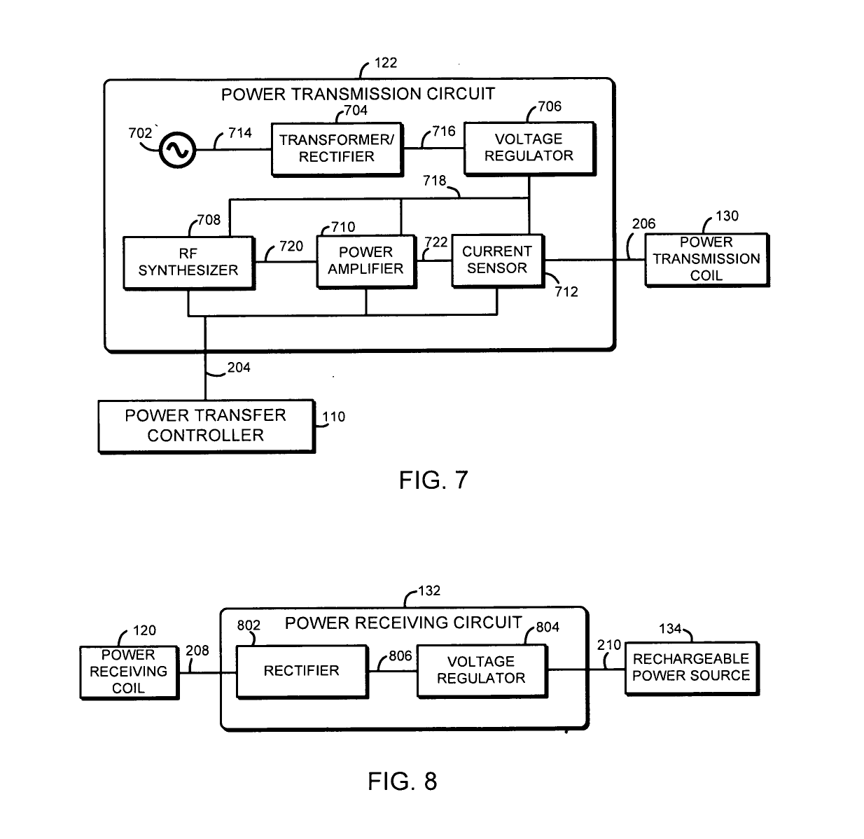

Referring now to FIG. 7, the power transmission circuit 122 may be embodied as any type of circuit or controller capable of energizing the power transmission coil 120 using the desired amount of current and/or voltage at the desired frequency and performing the additional functions described herein. In the illustrative embodiment, the power transmission circuit 122 includes a power source 702, a transformer/rectifier 704, a voltage regulator 706, a radio frequency (RF) synthesizer 708, a power amplifier 710, and a current sensor 712. The power source 702 is embodied as a power source connected to an electrical grid at an alternating current (AC) frequency of 60 Hz and a voltage of 110 or 220 volts in the illustrative embodiment. Of course, the power source 702 may be embodied as other types of power sources in other embodiments including, but not limited to, a power source running at a higher or lower frequency (including direct current) and/or a source running at a higher or lower voltage, such as a differently-configured electrical grid, a solar array, a wind turbine, or other power source.

The transformer/rectifier 704 is connected to the power source 702 through an AC power bus 714. The illustrative AC power bus 714 is illustratively embodied as a ground and a live wire, but may be embodied as other types of interconnects in other embodiments. In use, the transformer/rectifier 704 transforms the input voltage from the power source 702 to a voltage suitable for the power transmission circuit 122, such as 5, 10, 20, or 30 volts. The illustrative transformer/rectifier 704 also rectifies the alternating current of the power source into a direct current.

The voltage regulator 706 is connected to the transformer/rectifier 704 through a DC power bus 716. The illustrative DC power bus 716 is embodied as a ground wire and a live wire, but may be embodied as other types of interconnects in other embodiments. The voltage regulator 706 receives as an input voltage from the transformer/rectifier 704, which may not always be as stable or regulated as desired. As such, the voltage regulator 706 regulates the input voltage to generate a regulated output voltage on an output DC power bus 718. The DC power bus 718 provides regulated power to the RF synthesizer 708, the power amplifier 710, and the current sensor 712. As with the DC power bus 716, the output DC power bus 718 is illustratively embodied as a ground wire and a live wire, but may be embodied as other types of interconnects in other embodiments.

The RF synthesizer 708 synthesizes a radio-frequency signal at a desired frequency. In the illustrative embodiment, the radio-frequency signal is at or near 10 megahertz, and may be controlled by the power transfer controller 110 using the control bus 204. In other embodiments, the frequency synthesized by the RF synthesizer 708 may be lower or higher, such as in the kilohertz, megahertz, or gigahertz range. The RF synthesizer 708 sends the radio-frequency signal to the power amplifier 710 over a radio-frequency bus 720, which may be embodied as any suitable interconnect.

The power amplifier 710 receives the radio-frequency signal from the RF synthesizer 708 and amplifies the received radio-frequency signal to a higher power. The power output level of the power amplifier 710 may be controlled by the power transfer controller 110 using the control bus 204. The power amplifier 710 may be configured to output a specified voltage and/or a specified current. The output of the power amplifier 710 is sent to the current sensor 712 over a radio-frequency bus 722.

The current sensor 712 is configured to measure the current, voltage, and/or phase of the power signal passing through it. The current sensor 712 is configured to communicate such information to the power transfer controller 110 over the control bus 204. After passing through the current sensor 712, the output power is provided to the power transmission coil 120 over the power bus 206.

Of course, the illustrative power transmission circuit 122 depicted in FIG. 7 is not intended to be limiting, but is merely one of many possible embodiments of a power transmission circuit usable in the system 100. For example, other embodiments may combine certain circuits/devices such as the RF synthesizer 708 and power amplifier 710, may not include certain circuits/devices such as the voltage regulator 706, may have additional components such as multiple transformers and/or rectifiers, and/or may have the components arranged in a different circuit configuration, such as the voltage regulator 706 before the transformer/rectifier 704.

Referring now to FIG. 8, the power receiving circuit 132 may be embodied as any type of circuit or controller capable of receiving power from the power receiving coil 130 and converting the received power into a useful form of electrical operation for operation of the electric vehicle 200 (e.g., to a high-voltage DC power). In some embodiments, the electric vehicle 200 may be able to use the power received by the power receiving coil 130 directly (i.e., at the incoming current, voltage, and/or frequency). In such embodiments, the power receiving circuit 132 may be embodied as a simple interconnect, such as wires or cable capable of carrying the received power.

However, in the illustrative embodiment, the power receiving circuit 132 includes a rectifier 802 and a voltage regulator 804. In use, the power receiving circuit 132 receives power from the power receiving coil 130 over the power bus 208. In the illustrative embodiment, the frequency of the power signal received from power receiving coil 130 is at the same frequency of the RF synthesizer 708. The rectifier 802 converts the received power signal from an AC power signal to a DC signal, which is subsequently passed to the voltage regulator 804 over a DC power bus 806. The illustrative DC power bus 806 is embodied as a ground wire and a live wire, but may be embodied as other types of interconnects in other embodiments.

Because the voltage from the rectifier 802 may not be as stable or regulated as desired for various reasons, the voltage regulator 804 is configured to regulate the received DC voltage to generate a DC output signal on output DC power bus 210 that is more stable and/or regulated. The DC power bus 210 provides power to the electric vehicle 200, such as for charging a battery. The illustrative DC power bus 210 is embodied as a ground wire and a live wire, but may be embodied as other types of interconnects in other embodiments.

Like the power transmission circuit 122 depicted in FIG. 4, the power receiving circuit 132 depicted in FIG. 8 is not intended to be limiting, but is merely one of many possible embodiments of a power receiving circuit usable in the system 100. For example, in other embodiments, the power receiving circuit 132 may include additional circuits or devices such as a transformer, and/or may not include all of the circuits/devices depicted in FIG. 8.

Referring back to FIGS. 1-5, the proximity sensors 112 may be embodied as any type of sensor capable of producing or generating sensor data indicative of a distance between the power coils 120, 130. Although only two proximity sensors 112 are shown in FIGS. 1-5, it should be appreciated that the system 100 may include additional proximity sensors 112 in other embodiments (e.g., each of the power transfer systems 102, 104 may include proximity sensors. The proximity sensors 112 may be embodied as, or otherwise include one or more cameras, lidar devices, 3D cameras such as Intel® RealSense™ devices, magnetic sensors, radio frequency identification (RFID) readers, or any other proximity sensors. Additionally, although the proximity sensors 112 are described herein and used to determine the distance between the power coils 120, 130, the proximity sensor 112 (or other sensors) may also be used to detect or determine whether the electric vehicle 200 is in the proper position relative to the wireless power transmission system 102. In such embodiments, the wireless power transmission system 102 and/or the wireless power receiving system 104 may include additional dedicated circuitry or devices for detecting the proper positioning of the electric vehicle 200 relative to the wireless power transmission system 102. Such additional dedicated circuitry may be embodied as, or otherwise include, analog circuitry, digital circuitry, or some combination thereof, and may not necessarily be able to perform general computing tasks.

The actuator 114 may be embodied as any type of motor, actuator (e.g., hydraulic, electric, etc.), or other device capable of moving the power transmission coil 120 toward the power receiving coil 130 and controllable by the power transfer controller 110. Although each of the illustrative embodiments includes a single actuator 114 (either in the wireless power transmission system 102 or the wireless power receiving system 104), the system 100 may include multiple actuators 114 in other embodiments (e.g., an actuator in each of the power transfer systems 102, 104). Additionally, although the actuator 114 has been described as moving the corresponding power coil 120, 130 in a vertical direction, the actuator 114 may be capable of and configured to move the corresponding power coil 120, 130 in multiple directions (e.g., in a lateral direction) and/or tilt the power coil 120, 130.

The power transmission coil 120 and the power receiving coil 130 may be embodied as any type of power transfer elements capable of magnetically, capacitively, or inductively coupling with each using near-field interaction to transfer power from the power transmission coil 120 to the power receiving coil 130. In the illustrative embodiment, the power coils 120, 130 are embodied as coils of wire capable of electromagnetic coupling with each other. The size of the power coils 120, 130 may be dependent upon the operational parameters of the system 100 and the amount of power delivery desired.

The electric vehicle 200 may be embodied as any type of vehicle that is capable of motion and powered by a rechargeable power source. For example, the electric vehicle 200 may be embodied as a personal car, truck, large capacity transportation vehicle, taxi, truck, industrial device such as a forklift, an autonomous or semi-autonomous device such as a kind of robot, etc.

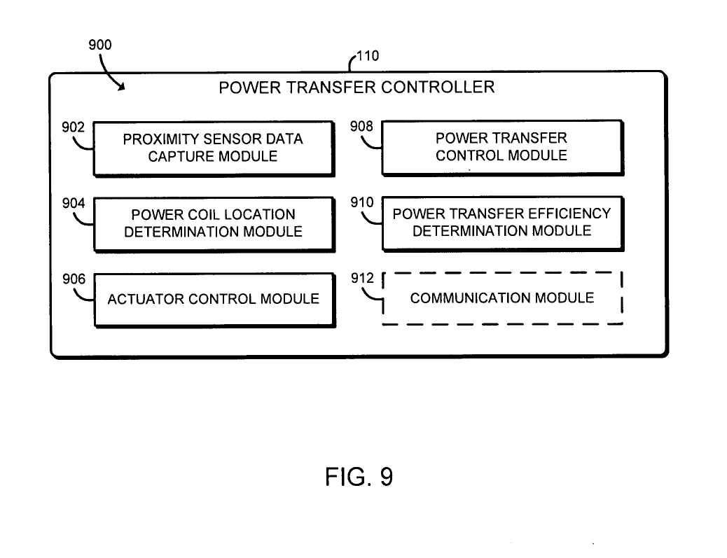

Referring now to FIG. 9, in use, the power transfer controller 110 may establish an environment 900. The illustrative environment 900 includes a proximity sensor data capture module 902, a power coil location determination module 904, an actuator control module 906, a power transfer control module 908, a power transfer efficiency determination module 910, and an optional communication module 912. The various modules of the environment 900 may be embodied as hardware, software, firmware, or a combination thereof. For example, the various modules, logic, and other components of the environment 900 may form a portion of, or otherwise be established by, the processor 602 or other hardware components of the power transfer controller 110. As such, in some embodiments, one or more of the modules of the environment 900 may be embodied as circuitry or collection of electrical devices (e.g., a proximity sensor data capture circuit 902, a power coil location determination circuit 904, an actuator control circuit 906, etc.). It should be appreciated that, in such embodiments, one or more of the circuits (e.g., the proximity sensor data capture circuit 902, the power coil location determination circuit 904, the actuator control circuit 906, etc.) may form a portion of one or more of the processor 602, the memory 604, the I/O subsystem 606, and/or other component. Additionally, in some embodiments, one or more of the illustrative modules may form a portion of another module and/or one or more of the illustrative modules may be independent of one another.

The proximity sensor data capture module 902 is configured to capture proximity sensor data from the proximity sensors 112. The proximity sensor data capture module 902 may capture sensor data continuously, continually, or periodically. Additionally or alternatively, the proximity sensor data capture module 902 may capture sensor data in response to an instruction to do so from the power transfer controller 110 or from a user of the power transfer controller 110. Further, in some embodiments, the proximity sensor data capture module 902 may receive the sensor data wirelessly from the proximity sensors 112 and/or from another component of the system 100 (e.g., from a power transfer controller of the wireless power receiving system 104).

The power coil location determination module 904 is configured to determine a location of one or both power coils 120, 130. For example, in embodiments in which the power transmission coil 120 is moved toward the power receiving coil 130, the power coil location determination module 904 may be configured to determine the location of the power receiving coil 130. Alternatively, in embodiments in which the power receiving coil 130 is moved toward the power transmission coil 120, the power coil location determination module 904 may be configured to determine the location of the power transmission coil. Depending on the embodiment of the proximity sensors 116, the power coil location determination module 904 may determine the location of the corresponding power coil 120, 130 using one or more of a variety of techniques, such image analysis, machine learning algorithms, or other algorithms such as applying fixed transformation to the location of one or more RFID tags associated with the electric vehicle 200. In the illustrative embodiment, the power coil location determination module 904 determines a distance between the power coils 120, 130, rather than an absolute position of the corresponding power coil 120, 130.

The actuator control module 906 is configured to control the actuator 114 to control position of the corresponding power coil 120, 130. As discussed above, the actuator control module 906 may be capable of moving the power coil 120, 130 in a vertical direction and/or other directions (e.g., a lateral direction) depending on the particular embodiment.

The power transfer control module 908 is configured to control the power transmission circuit 122 to energize the power transmission coil 120 and, in some embodiments, receive feedback from the power transmission circuit 122. The illustrative power transfer control module 908 is able to control the frequency and power of the output of the power transmission circuit 122, and may be configured to measure the current, voltage, and/or phase of the output of the power transmission circuit 122 to the power transmission coil 120. The power transfer control module 908 may control the power transmitted based on factors such as the distance between the power transmission coil 120 and the power receiving coil 130, the efficiency of the power transfer, and/or a minimum power transfer efficiency that may be pre-determined. In embodiments in which the power transfer controller 110 is included in the wireless power receiving system 104 (e.g., see FIGS. 3 and 4), the power transfer controller 110 may control the power transmission circuit 122, and receive feedback therefrom, via wireless communication signals. In such embodiments, as discussed above, the power transfer controller 110 may communicate directly with the power transmission circuit 122 or via another power transfer controller included in the wireless power transmission system 102.

The power transfer efficiency determination module 910 is configured to determine the efficiency of power transfer from the power transmission coil 120 to the power receiving coil 130. The illustrative power transfer efficiency determination module 910 is configured to determine the efficiency based on measurements received by the power transfer control module 908. Additionally or alternatively, the power transfer efficiency determination module 910 may determine the efficiency based on pre-determined factors such as the Q-factor of the power transmission coil 120 and/or the power receiving coil 130, and/or may determine the efficiency based on communication with the electric vehicle 200.

The communication module 912 is configured to communicate with other computing or electrical devices of the system 100, such as components of the other wireless power system 102, 104. To do so, the communication module 912 may communicate directly or indirectly through a network, using, for example, Ethernet, Bluetooth®, Wi-Fi®, WiMAX, near field communication (NFC), etc.

Referring now to FIG. 1000, in use, the power transfer controller 110 may execute a method 1000 for wireless charging an electric vehicle 200. The method 1000 begins with block 1002 in which the power transfer controller 110 determine whether to wireless transfer power. That is, the power transfer controller 110 may be configured initiate the power transfer only under specific conditions, such as in response to a command to do so. In this way, the power transfer functionality of the system 100 may be enabled or disabled as desired.

If the power transfer controller 110 determines that wireless transfer of power has been enabled, the method 1000 advances to block 1004. In block 1004, the power transfer controller 110 monitors for the position of the electric vehicle 200 relative to the wireless power transmission system 102. To do so, in block 1006, the power transfer controller 110. Of course, in other embodiments, other sensors and/or technologies may be used to detect the position of the electric vehicle 200 relative to the wireless power transmission system 102.

In block 1008, the power transfer controller 110 determines whether the electric vehicle 200 is properly positioned relative to the wireless power transmission system 102. That is, the power transfer controller 110 determines whether the electric vehicle 200 is in a position such that one or more of the power coils 120, 130 may be moved toward the other. For example, in the illustrative embodiment, the power transfer controller 110 determines that the electric vehicle 200 is properly positioned when the power receiving coil 130 is positioned substantially vertically over the power transmission coil 120. Of course, in embodiments in which the actuator 114 is configured to move the power coil 120, 130 in multiple directions, the degree of registry between the power coils 120, 130 may be greater.

If the power transfer controller 110 determines that the electric vehicle 200 is not properly positioned, the method 1000 loops back to block 1004 in which the power transfer controller 110 continues to monitor the positioning of the electric vehicle 200 relative to the wireless power transmission system 102. If, however, the power transfer controller 110 determines that the electric vehicle 200 is properly positioned, the method 1000 advances to block 1010 in which the power transfer controller 110 determines a minimum wireless power transfer efficiency. In some embodiments, the minimum wireless power transfer efficiency may be pre-determined and stored in a data storage of the power transfer controller 110 (e.g., in the memory 604). For example, the minimum wireless power transfer efficiency may be stored as a desired value such as 80%, 85%, 90%, or 95%, and simply retrieved by the power transfer controller 110 from storage. However, in other embodiments, the minimum wireless power transfer efficiency may be related to the strength of the field generated by the power transmission coil 120 and/or the power receiving coil 130, particularly in comparison to safety thresholds. Safety thresholds may be predetermined based on, e.g., published safety standards for exposure to electromagnetic fields.

Subsequently, in block 1012, the power transfer controller 110 determines the threshold distance required between the power transmission coil 120 and the power receiving coil 130 to achieve the minimum wireless power transfer efficiency. For example, in some embodiments, the threshold distance may be determined based on a mathematical model or equation that indicates the resulting coupling efficiency between the power transmission coil 120 and the power receiving coil 130 as a function of the distance between the power coils 120, 130. In some embodiments, such a model may be based on or derived from data gathered during operation of the system 100 (e.g., based on operation of the wireless power system 102, 104). Additionally or alternatively, the model may be based on a theoretical model of the system without any measurements specific to that system.

In block 1014, the power transfer controller 110 controls the actuator 114 to move the corresponding power coil 120, 130 toward the other power coil. For example, in embodiments in which the power transfer controller 110 forms part of the wireless power transmission system 102, the power transfer controller 110 controls the actuator 114 to move the power transmission coil 120 in an upwardly vertical direction toward the power receiving coil 130. Alternatively, in embodiments in which the power transfer controller 110 forms part of the wireless power receiving system 104, the power transfer controller 110 controls the actuator 114 to move the power receiving coil 130 in a downwardly vertical direction toward the power transmission coil 120. As discussed above, the power transfer controller 110 may control the actuator 114 to move corresponding power coil 120, 130 in other directions and angles in other embodiments. The power transfer controller 110 may control the actuator 114, and correspondingly the movement of the power coil 120, 130, using any suitable control mechanism including, for example, proportional-integral-derivative control, a pre-existing model of how the position of the power coil 120, 130 varies as a function of the input power to the actuator 114, etc.

In block 1020, the power transfer controller 110 monitors the distance between the power coils 120, 130. To do so, as shown in block 1022, the power transfer controller 110 may capture the sensor data produced by the proximity sensors 112 and determine the present distance between the power coils 120, 130 based thereon. The power transfer controller 110 may utilize any suitable mechanism to determine the distance based on the sensor data depending on, for example, the type of proximity sensors 112 and/or the type of sensor data produced.

In block 1024, the power transfer controller 110 determines whether the moved power coil 120, 130 is properly positioned. For example, in the power transfer controller 110 may determine that the corresponding power coil 120, 130 is properly positioned when the determined distance between the power coils 120, 130 satisfies the threshold distance determined in block 1012 (e.g., is equal or less than the threshold distance). In other embodiments, however, the power transfer controller 110 may determine that the corresponding power coil 120, 130 is properly positioned when the determined distance between the power coils 120, 130 satisfies a fixed reference threshold. Of course, in some embodiments, a minimum distance between the power coils 120, 130 may also be maintained to ensure the power coils 120, 130 do not collide with each other (e.g., if the electric vehicle 200 is moving).

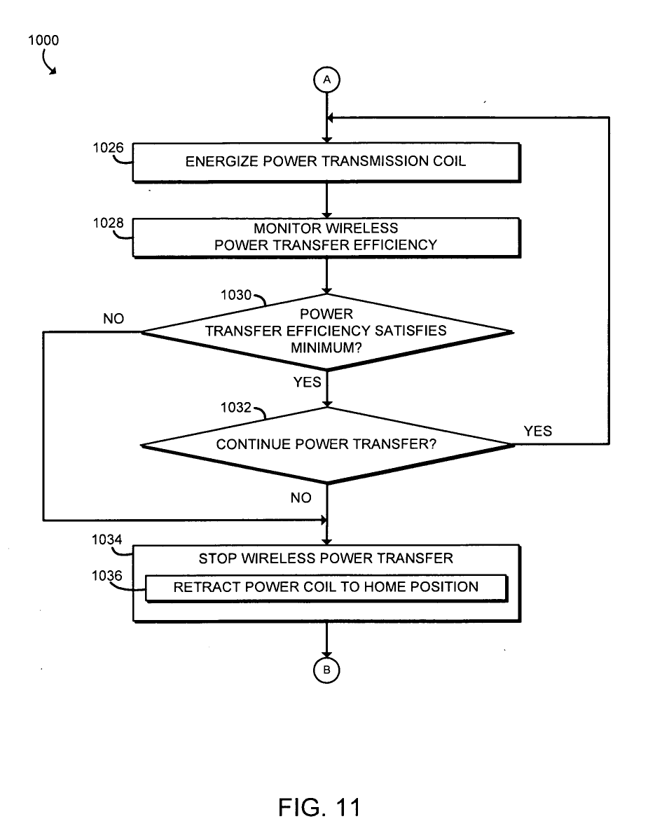

If the moved power coil 120, 130 is not yet properly positioned, the method 1000 loops back to block 1014 in which the power transfer controller 110 continues to move the corresponding power coil 120, 130. However, if the power transfer controller 110 determines that the moved power coil 120, 130 is properly positioned, the method 1000 advances to block 1026 of FIG. 11. In block 1026, the power transfer controller 110 controls the power transmission circuit 122 to energize the power transmission coil 120 to transfer power to the power receiving coil 130. As discussed above, in embodiments in which the power transfer controller 110 is included in the wireless power receiving system 104, the power transfer controller 110 may control the power transmission circuit 122 via wireless communication or the like.

In block 1028, the power transfer controller 110 monitors the wireless power transfer efficiency during the transfer of power from the power transmission coil 120 to the power receiving coil 130. As discussed above, the power transfer controller 110 may do so based on measurements received from the power transmission circuit 122, based on pre-determined factors such as the Q-factor of the power transmission coil 120 and/or the power receiving coil 130, and/or based on communication with the electric vehicle 200.

Subsequently, in block 1030, the power transfer controller 110 determines whether the present wireless power transfer efficiency satisfies (e.g., equals or exceeds) the minimum power transfer efficiency as determined in block 1010. If so, the method 1000 advances to block 1030 in which the power transfer controller 110 determines whether to continue the power transfer. For example, in some embodiments, the power transfer may be continued for a pre-determine amount of time, until a command signal is received from the electric vehicle 200 (e.g., confirming the rechargeable power source 134 is fully charged), or until some other condition is satisfied. If the power transfer is to continue, the method 1000 loops back to block 1026 in which the power transmission circuit 122 continues to energize the power transmission coil 120.

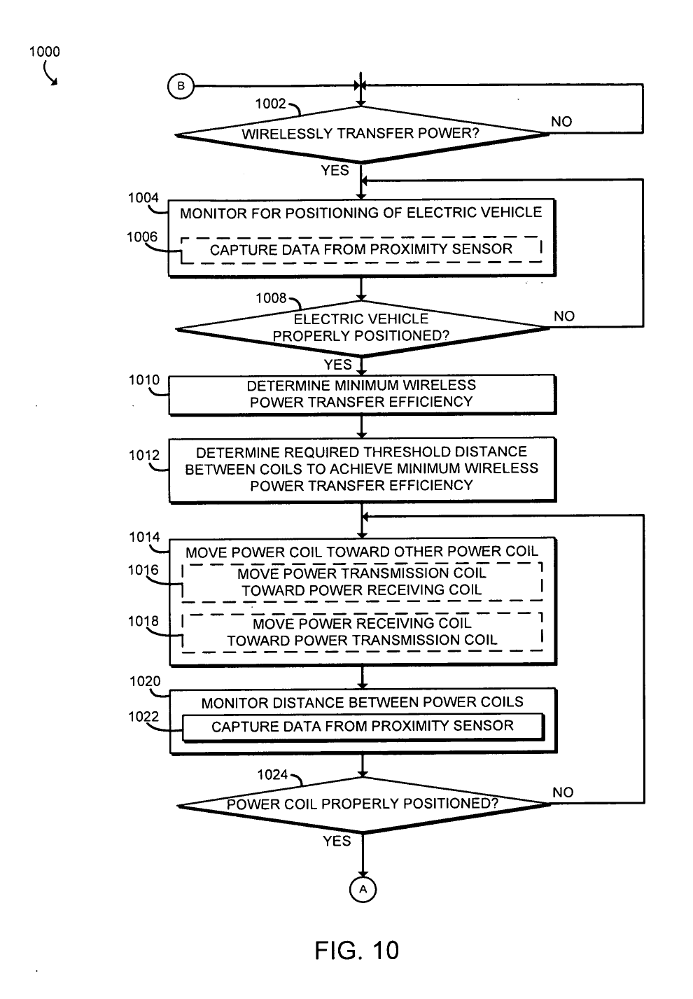

If the power transfer is determined to not be continued in block 1032 or if the present power transfer efficiency is determined to not satisfied the minimum power transfer efficiency, the method 1000 advances to block 1034. In block 1034, the power transmission circuit 122 stops the energizing of the power transmission coil 120 to stop power transfer to the power receiving coil 130. Additionally, in block 1036, the power coil 120, 130 that was previously moved in block 1014 is retracted back to home position. The method 1000 subsequently loops back to block 1002 of FIG. 10 to determine if another wireless power transfer is desired.

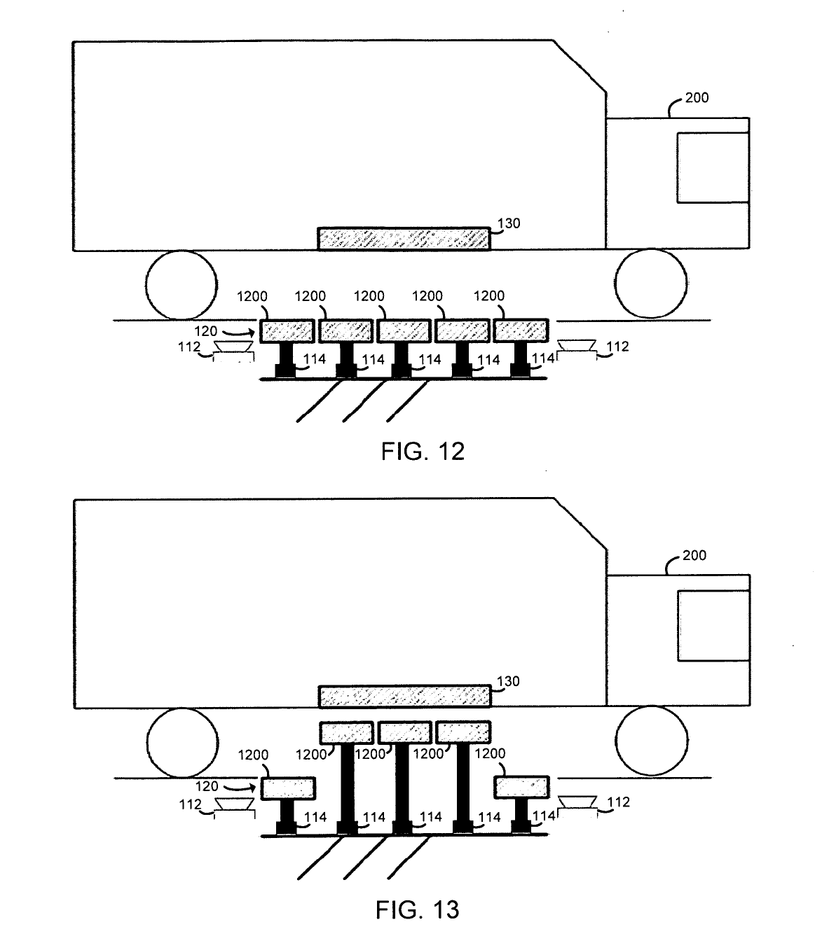

Referring now to FIG. 12, in some embodiments, the power transmission coil 120 may be embodied as two or more sub-coils 1200, each of which may be operated independently using a corresponding actuator 114. In such embodiments, the power transmission coil 120 is capable of accommodating power receiving coils 130 of varying sizes (e.g., in the case in which the power receiving coil is not the same size as the power transmitting coil 120). For example, the power receiving coil 130 may have a different diameter, may cover a different amount of area, or may otherwise be a different size from the power transmitting coil 120. In such an embodiment, the power transfer controller 110 may be configured to determine the size of the power receiving coil 130 in block 1012 of method 1000 (see FIG. 10) by, e.g., communicating with a compute device of the electric vehicle 200 or detecting the size of the power receiving coil 130 using the sensor data from the proximity sensors 112. The power transmission coil 120 may be moved upwardly toward the power receiving coil 130 in a vertical direction by moving a subset of the two or more sub-coils 1200, as shown in FIG. 13 (see block 1014 of FIG. 10). In some embodiments, the sub-coils 1200 that are not moved may be disconnected from the power transmission circuit 122, while the moved sub-coils 120 are energized (see block 1026 of FIG. 11). Additionally or alternatively, in some embodiments, the power receiving coil 130 may be embodied as two or more sub-coils), which may be moved in a similar manner in embodiments similar to those shown in FIGS. 4-5.

### Examples

Illustrative examples of the devices, systems, and methods disclosed herein are provided below. An embodiment of the devices, systems, and methods may include any one or more, and any combination of, the examples described below.

Example 1 includes a wireless charging system to control wireless charging of an electric vehicle, the wireless charging system comprising a first power coil; an actuator operatively coupled to the first power coil to move the first power coil; a proximity sensor to produce sensor data indicative of a distance between the first power coil and a second power coil; a power transfer controller to control, based on the distance, the actuator to move the first power coil toward the second power coil and control transfer of power (i) from the first power coil to the second power coil or (ii) from the second power coil to the first power coil.

Example 2 includes the subject matter of Example 1, and wherein the first power coil comprises a power transmission coil and the second power coil comprise a power receiving coil located in the electric vehicle, and wherein to control the actuator comprises to control, based on the distance, the actuator to move the power transmission coil toward the power receiving coil.

Example 3 includes the subject matter of any of Examples 1 and 2, and further including a power transmission circuit to energize the power transmission coil, wherein the power transfer controller is to control the power transmission circuit to energize the power transmission coil based on the distance to transfer power from the power transmission coil to the power receiving coil.

Example 4 includes the subject matter of any of Examples 1-3, and wherein the power transfer controller is to control, based on the distance, the actuator to move the power transmission coil to a reference distance from the power receiving coil and control the power transmission circuit to energize the power transmission coil in response to the power transmission coil being positioned at the reference distance from the second power coil.

Example 5 includes the subject matter of any of Examples 1-4, and wherein the actuator is operatively coupled to the power transmission coil to move the power transmission coil upwardly in a vertical direction toward the power receiving coil.

Example 6 includes the subject matter of any of Examples 1-5, and wherein the wireless charging system is located in the electric vehicle, the first power coil comprises a power receiving coil located in the electric vehicle, and the second power coil comprises a power transmission coil, and wherein to control the actuator comprises to control, based on the distance the actuator to move the power receiving coil toward the power transmission coil.

Example 7 includes the subject matter of any of Examples 1-6, and wherein the power transfer controller is to control the actuator to move the power receiving coil toward the power transmission coil while the electric vehicle is in motion.

Example 8 includes the subject matter of any of Examples 1-7, and wherein the actuator is operatively coupled to the power receiving coil to move the power receiving coil downwardly from the electric vehicle in a vertical direction toward the power transmission coil.

Example 9 includes the subject matter of any of Examples 1-8, and wherein the actuator is operatively coupled to the first power coil to move the first power coil in a vertical direction toward the second power coil.

Example 10 includes the subject matter of any of Examples 1-9, and wherein the proximity sensor is a lidar device.

Example 11 includes the subject matter of any of Examples 1-10, and wherein the proximity sensor is a 3D camera.

Example 12 includes the subject matter of any of Examples 1-11, and wherein the power transfer controller is to determine the distance based on the sensor data.

Example 13 includes the subject matter of any of Examples 1-12, and wherein the power transfer controller is further to determine (i) a minimum power transfer efficiency and (ii) a threshold distance based on the minimum power transfer efficiency, a threshold distance, wherein to control the actuator to move the first power coil toward the second power coil comprises to control the actuator to move the first power coil toward the second power coil until the distance between the first power coil and the second power coil satisfies the threshold distance.

Example 14 includes the subject matter of any of Examples 1-13, and wherein to determine the minimum power transfer efficiency comprises to determine the minimum power transfer efficiency based on a safety threshold.

Example 15 includes the subject matter of any of Examples 1-14, and, wherein the first power coil comprises two or more sub-coils, wherein the power transfer controller is further to determine a size of the second power coil and to select one or more sub-coils of the two or more sub-coils based on the size of the second power coil, and wherein to control the actuator to move the first power coil toward the second power coil comprises to control the actuator to move the selected one or more sub-coils of the two or more sub-coils toward the second power coil.

Example 16 includes the subject matter of any of Examples 1-15, and wherein the sensor data is further indicative of the size of the second power coil, and wherein to determine the size of the second power coil comprises to determine a size of the second power coil based on the sensor data.

Example 17 includes the subject matter of any of Examples 1-16, and wherein to determine the size of the second power coil comprises to determine a size of the second power coil by communicating with a compute device associated with the second power coil.

Example 18 includes the subject matter of any of Examples 1-17, and wherein to determine a size of the second power coil comprises to determine a diameter of the second power coil.

Example 19 includes the subject matter of any of Examples 1-18, and wherein to determine a size of the second power coil comprises to determine an area of the second power coil.

Example 20 includes a method for wireless charging an electric vehicle, the method comprising obtaining, by a power transfer controller and from a proximity sensor, sensor data indicative of a distance between a first power coil and a second power coil; controlling, by the power transfer controller and based on the distance, an actuator to move the first power coil toward the second power coil; and controlling, by the power transfer controller and based on the distance, transfer of power (i) from the first power coil to the second power coil or (ii) from the second power coil to the first power coil.

Example 21 includes the subject matter of Example 20, and wherein the first power coil comprises a power transmission coil and the second power coil comprise a power receiving coil located in the electric vehicle, and wherein controlling the actuator comprises controlling, based on the distance, the actuator to move the power transmission coil toward the power receiving coil.

Example 22 includes the subject matter of any of Examples 20 and 21, and further including energizing, by the power transfer controller, the power transmission coil based on the distance to transfer power from the power transmission coil to the power receiving coil.

Example 23 includes the subject matter of any of Examples 20-22, and wherein controlling the actuator comprises controlling, based on the distance, the actuator to move the power transmission coil to a reference distance from the power receiving coil, and controlling transfer of power comprises energizing the power transmission coil in response to the power transmission coil being positioned at the reference distance from the second power coil.

Example 24 includes the subject matter of any of Examples 20-23, and wherein controlling the actuator comprises controlling, based on the distance, the actuator to move the power transmission coil upwardly in a vertical direction toward the power receiving coil.

Example 25 includes the subject matter of any of Examples 20-24, and wherein the wireless charging system is located in the electric vehicle, the first power coil comprises a power receiving coil located in the electric vehicle, and the second power coil comprises a power transmission coil, and wherein controlling the actuator comprises controlling, based on the distance, the actuator to move the power receiving coil toward the power transmission coil.

Example 26 includes the subject matter of any of Examples 20-25, and wherein controlling the actuator comprises controlling, based on the distance, the actuator to move the power receiving coil toward the power transmission coil while the electric vehicle is in motion.

Example 27 includes the subject matter of any of Examples 20-26, and controlling the actuator comprises controlling, based on the distance, the actuator to move the power receiving coil downwardly from the electric vehicle in a vertical direction toward the power transmission coil.

Example 28 includes the subject matter of any of Examples 20-27, and wherein controlling the actuator comprises controlling, based on the distance, the actuator to move the first power coil in a vertical direction toward the second power coil.

Example 29 includes the subject matter of any of Examples 20-28, and wherein obtaining the sensor data comprises obtaining sensor data indicative of a distance between a first power coil and a second power coil from a lidar device.

Example 30 includes the subject matter of any of Examples 20-29, and wherein obtaining the sensor data comprises obtaining sensor data indicative of a distance between a first power coil and a second power coil from a 3D camera.

Example 31 includes the subject matter of any of Examples 20-30, and further including determining, by the power transfer controller, the distance based on the sensor data.

Example 32 includes the subject matter of any of Examples 20-31 and further including determining, by the power transfer controller, a minimum power transfer efficiency; and determining, by the power transfer controller, a threshold distance, wherein controlling the actuator to move the first power coil toward the second power coil comprises controlling the actuator to move the first power coil toward the second power coil until the distance between the first power coil and the second power coil satisfies the threshold distance.

Example 33 includes the subject matter of any of Examples 20-32, and wherein determining the minimum power transfer efficiency comprises determining the minimum power transfer efficiency based on a safety threshold.

Example 34 includes the subject matter of any of Examples 20-33, and wherein the first power coil comprises two or more sub-coils, further comprising determining, by the power transfer controller, a size of the second power coil and selecting, by the power transfer controller, one or more sub-coils of the two or more sub-coils based on the size of the second power coil, wherein controlling the actuator to move the first power coil toward the second power coil comprises controlling the actuator to move the selected one or more sub-coils of the two or more sub-coils toward the second power coil.

Example 35 includes the subject matter of any of Examples 20-34, and wherein the sensor data is further indicative of the size of the second power coil, and wherein determining the size of the second power coil comprises determining a size of the second power coil based on the sensor data.

Example 36 includes the subject matter of any of Examples 20-35, and wherein determining the size of the second power coil comprises determining a size of the second power coil by communicating with a compute device associated with the second power coil.

Example 37 includes the subject matter of any of Examples 20-36, and wherein determining a size of the second power coil comprises determining a diameter of the second power coil.

Example 38 includes the subject matter of any of Examples 20-37, and wherein determining a size of the second power coil comprises determining an area of the second power coil.

Example 39 includes one or more machine-readable storage media comprising a plurality of instructions stored thereon that in response to being executed result in a computing device performing the method of any of Examples 20-38.

Example 40 includes a wireless charging system to control wireless charging of an electric vehicle, the wireless charging system comprising means for obtaining, from a proximity sensor, sensor data indicative of a distance between a first power coil and a second power coil; means for controlling, based on the distance, an actuator to move the first power coil toward the second power coil; and means for controlling, based on the distance, transfer of power (i) from the first power coil to the second power coil or (ii) from the second power coil to the first power coil.

Example 41 includes the subject matter of Example 40, and, wherein the first power coil comprises a power transmission coil and the second power coil comprise a power receiving coil located in the electric vehicle, and wherein means for controlling the actuator comprises means for controlling, based on the distance, the actuator to move the power transmission coil toward the power receiving coil.

Example 42 includes the subject matter of any of Examples 40 and 41, and further including means for energizing the power transmission coil based on the distance to transfer power from the power transmission coil to the power receiving coil.

Example 43 includes the subject matter of any of Examples 40-42, and wherein means for controlling the actuator comprises means for controlling, based on the distance, the actuator to move the power transmission coil to a reference distance from the power receiving coil, and means for controlling transfer of power comprises means for energizing the power transmission coil in response to the power transmission coil being positioned at the reference distance from the second power coil.

Example 44 includes the subject matter of any of Examples 40-43, and wherein means for controlling the actuator comprises means for controlling, based on the distance, the actuator to move the power transmission coil upwardly in a vertical direction toward the power receiving coil.

Example 45 includes the subject matter of any of Examples 40-44, and wherein the wireless charging system is located in the electric vehicle, the first power coil comprises a power receiving coil located in the electric vehicle, and the second power coil comprises a power transmission coil, and wherein means for controlling the actuator comprises means for controlling, based on the distance, the actuator to move the power receiving coil toward the power transmission coil.

Example 46 includes the subject matter of any of Examples 40-45, and wherein means for controlling the actuator comprises means for controlling, based on the distance, the actuator to move the power receiving coil toward the power transmission coil while the electric vehicle is in motion.

Example 47 includes the subject matter of any of Examples 40-46, and wherein means for controlling the actuator comprises means for controlling, based on the distance, the actuator to move the power receiving coil downwardly from the electric vehicle in a vertical direction toward the power transmission coil.

Example 48 includes the subject matter of any of Examples 40-47, and wherein means for controlling the actuator comprises means for controlling, based on the distance, the actuator to move the first power coil in a vertical direction toward the second power coil.

Example 49 includes the subject matter of any of Examples 40-48, and wherein means for obtaining the sensor data comprises means for obtaining sensor data indicative of a distance between a first power coil and a second power coil from a lidar device.

Example 50 includes the subject matter of any of Examples 40-49, and wherein means for obtaining the sensor data comprises obtaining sensor data indicative of a distance between a first power coil and a second power coil from a 3D camera.

Example 51 includes the subject matter of any of Examples 40-50, and further including means for determining the distance based on the sensor data.

Example 52 includes the subject matter of any of Examples 40-51, and further including means for determining a minimum power transfer efficiency; and means for determining a threshold distance, wherein the means for controlling the actuator to move the first power coil toward the second power coil comprises means for controlling the actuator to move the first power coil toward the second power coil until the distance between the first power coil and the second power coil satisfies the threshold distance.

Example 53 includes the subject matter of any of Examples 40-52, and wherein the means for determining the minimum power transfer efficiency comprises means for determining the minimum power transfer efficiency based on a safety threshold.

Example 54 includes the subject matter of any of Examples 40-53, and wherein the first power coil comprises two or more sub-coils, further comprising means for determining a size of the second power coil and means for selecting one or more sub-coils of the two or more sub-coils based on the size of the second power coil, wherein the means for controlling the actuator to move the first power coil toward the second power coil comprises means for controlling the actuator to move the selected one or more sub-coils of the two or more sub-coils toward the second power coil.

Example 55 includes the subject matter of any of Examples 40-54, and wherein the sensor data is further indicative of the size of the second power coil, and wherein the means for determining the size of the second power coil comprises means for determining a size of the second power coil based on the sensor data.

Example 56 includes the subject matter of any of Examples 40-55, and wherein the means determining the size of the second power coil comprises means determining a size of the second power coil by communicating with a compute device associated with the second power coil.

Example 57 includes the subject matter of any of Examples 40-56, and wherein the means for determining a size of the second power coil comprises means for determining a diameter of the second power coil.

Example 58 includes the subject matter of any of Examples 40-57, and wherein the means for determining a size of the second power coil comprises means for determining an area of the second power coil.

1. A wireless charging system to control wireless charging of an electric vehicle, the wireless charging system comprising:
a first power coil;
an actuator operatively coupled to the first power coil to move the first power coil;
a proximity sensor to produce sensor data indicative of a distance between the first power coil and a second power coil;
a power transfer controller to control, based on the distance, the actuator to move the first power coil toward the second power coil and control transfer of power (i) from the first power coil to the second power coil or (ii) from the second power coil to the first power coil.

2. The wireless charging system of claim 1, wherein the first power coil comprises a power transmission coil and the second power coil comprise a power receiving coil located in the electric vehicle, and
wherein to control the actuator comprises to control, based on the distance, the actuator to move the power transmission coil toward the power receiving coil.

3. The wireless charging system of claim 1, wherein the wireless charging system is located in the electric vehicle, the first power coil comprises a power receiving coil located in the electric vehicle, and the second power coil comprises a power transmission coil, and
wherein to control the actuator comprises to control, based on the distance the actuator to move the power receiving coil toward the power transmission coil.

4. The wireless charging system of claim 3, wherein the power transfer controller is to control the actuator to move the power receiving coil toward the power transmission coil while the electric vehicle is in motion.

5. The wireless charging system of claim 1, wherein the proximity sensor is a 3D camera.

6. The wireless charging system of claim 1, wherein the power transfer controller is to determine the distance based on the sensor data.

7. The wireless charging system of claim 1, wherein the power transfer controller is further to determine (i) a minimum power transfer efficiency and (ii) a threshold distance based on the minimum power transfer efficiency,
wherein to control the actuator to move the first power coil toward the second power coil comprises to control the actuator to move the first power coil toward the second power coil until the distance between the first power coil and the second power coil satisfies the threshold distance.

8. The wireless charging system of claim 7, wherein to determine the minimum power transfer efficiency comprises to determine the minimum power transfer efficiency based on a safety threshold.

9. The wireless charging system of claim 1,
wherein the first power coil comprises two or more sub-coils,
wherein the power transfer controller is further to determine a size of the second power coil and to select one or more sub-coils of the two or more sub-coils based on the size of the second power coil, and
wherein to control the actuator to move the first power coil toward the second power coil comprises to control the actuator to move the selected one or more sub-coils of the two or more sub-coils toward the second power coil.

10. The wireless charging system of claim 9, wherein the sensor data is further indicative of the size of the second power coil, and wherein to determine the size of the second power coil comprises to determine a size of the second power coil based on the sensor data.

11. The wireless charging system of claim 9, wherein to determine a size of the second power coil comprises to determine an area of the second power coil.

12. One or more machine-readable media comprising a plurality of instructions stored thereon that, when executed, cause a wireless charging system to:
move a first power coil by an actuator operatively coupled to the first power coil;
produce sensor data indicative of a distance between the first power coil and a second power coil;
control, based on the distance, the actuator to move the first power coil toward the second power coil and control transfer of power (i) from the first power coil to the second power coil or (ii) from the second power coil to the first power coil.

13. The one or more machine-readable media of claim 12, wherein the first power coil comprises a power transmission coil and the second power coil comprise a power receiving coil located in the electric vehicle, and
wherein to control the actuator comprises to control, based on the distance, the actuator to move the power transmission coil toward the power receiving coil.

14. The one or more machine-readable media of claim 12, wherein the wireless charging system is located in the electric vehicle, the first power coil comprises a power receiving coil located in the electric vehicle, and the second power coil comprises a power transmission coil, and
wherein to control the actuator comprises to control, based on the distance the actuator to move the power receiving coil toward the power transmission coil.

15. The one or more machine-readable media of claim 14, wherein the plurality of instructions further cause the wireless charging system to control the actuator to move the power receiving coil toward the power transmission coil while the electric vehicle is in motion.

16. The one or more machine-readable media of claim 12, wherein the plurality of instructions further cause the wireless charging system to determine the distance based on the sensor data.

17. The one or more machine-readable media of claim 12, wherein the plurality of instructions further cause the wireless charging system to determine (i) a minimum power transfer efficiency and (ii) a threshold distance based on the minimum power transfer efficiency,
wherein to control the actuator to move the first power coil toward the second power coil comprises to control the actuator to move the first power coil toward the second power coil until the distance between the first power coil and the second power coil satisfies the threshold distance.

18. The one or more machine-readable media of claim 12,
wherein the first power coil comprises two or more sub-coils,
wherein the plurality of instructions further cause the wireless charging system to determine a size of the second power coil and to select one or more sub-coils of the two or more sub-coils based on the size of the second power coil, and
wherein to control the actuator to move the first power coil toward the second power coil comprises to control the actuator to move the selected one or more sub-coils of the two or more sub-coils toward the second power coil.

19. The one or more machine-readable media of claim 18, wherein the sensor data is further indicative of the size of the second power coil, and wherein to determine the size of the second power coil comprises to determine a size of the second power coil based on the sensor data.

20. A method for wireless charging an electric vehicle, the method comprising:
obtaining, by a power transfer controller and from a proximity sensor, sensor data indicative of a distance between a first power coil and a second power coil;
controlling, by the power transfer controller and based on the distance, an actuator to move the first power coil toward the second power coil; and
controlling, by the power transfer controller and based on the distance, transfer of power (i) from the first power coil to the second power coil or (ii) from the second power coil to the first power coil.

21. The method of claim 20, wherein the first power coil comprises a power transmission coil and the second power coil comprise a power receiving coil located in the electric vehicle, and
wherein controlling the actuator comprises controlling, based on the distance, the actuator to move the power transmission coil toward the power receiving coil.

22. The method of claim 21, wherein the wireless charging system is located in the electric vehicle, the first power coil comprises a power receiving coil located in the electric vehicle, and the second power coil comprises a power transmission coil, and
wherein controlling the actuator comprises controlling, based on the distance, the actuator to move the power receiving coil toward the power transmission coil.

23. The method of claim 22, wherein controlling the actuator comprises controlling, based on the distance, the actuator to move the power receiving coil toward the power transmission coil while the electric vehicle is in motion.

24. The method of claim 20, further comprising:
determining, by the power transfer controller, a minimum power transfer efficiency; and
determining, by the power transfer controller, a threshold distance,
wherein controlling the actuator to move the first power coil toward the second power coil comprises controlling the actuator to move the first power coil toward the second power coil until the distance between the first power coil and the second power coil satisfies the threshold distance.

25. The method of claim 20,
wherein the first power coil comprises two or more sub-coils,
further comprising determining, by the power transfer controller, a size of the second power coil and selecting, by the power transfer controller, one or more sub-coils of the two or more sub-coils based on the size of the second power coil,
wherein controlling the actuator to move the first power coil toward the second power coil comprises controlling the actuator to move the selected one or more sub-coils of the two or more sub-coils toward the second power coil.
